(19) United States
(12) Patent Application Publication
(10) Pub. No.: US 2022/0140365 A1
(43) Pub. Date: May 5, 2022

(54) ESS SYSTEM FOR CHARGING FUEL CELL ELECTRIC VEHICLE AND ELECTRIC VEHICLE

(71) Applicants: SIGNET EV INC., Jeollanam-do (KR); SIGNET ENERGY, Jeju-si (KR)

(72) Inventors: Taeeun Mun, Seoul (KR); Ho Byung CHAE, Seoul (KR); Jong Hoon SHIN, Seoul (KR)

(73) Assignees: SIGNET EV INC., Jeollanam-do (KR); SIGNET ENERGY, Jeju-si (KR)

(21) Appl. No.: 17/383,478

(22) Filed: Jul. 23, 2021

(30) Foreign Application Priority Data
Nov. 2, 2020 (KR) 10-2020-0144080

(51) Int. Cl. H01M 8/04828; H01M 16/00; H02J 7/34

(52) U.S. Cl. CPC H01M 8/0494; H01M 2250/20; H02J 7/34; H01M 16/003

(57) ABSTRACT

A fuel cell electric vehicle and an electric vehicle, includes: a hydrogen tank that stores hydrogen and supplies the hydrogen to a fuel cell electric vehicle dispenser or a fuel cell stack pack; a fuel cell stack pack that operates in an electrolysis mode or a fuel cell mode; a battery pack that charges and stores DC power converted from AC power of a grid or power supplied from the fuel cell stack pack, and supplies the stored power to an electric vehicle dispenser; and a control unit that controls power transfer between the fuel cell stack pack and the battery pack and determines a driving mode of the fuel cell stack pack.

### TECHNICAL FIELD

The present disclosure relates to an ESS system for charging a fuel cell electric vehicle and an electric vehicle, and more particularly, an ESS system for charging a fuel cell electric vehicle and an electric vehicle, which is capable of simultaneously charging the fuel cell electric vehicle and the electric vehicle.

### BACKGROUND ART

In recent years, research and development on alternative energy have been actively conducted in order to cope with changes in the climate environment. In particular, interest in a fuel cell and an energy storage system (ESS) has been continually increased to focus on electric energy and hydrogen energy.

Currently, each country is putting forward the introduction of a hydrogen fuel cell electric vehicle (fuel cell electric vehicle (FCEV)) and an electric vehicle (EV) in order to phase out an internal combustion engine. However, there are many difficulties in the initial cost and continuous maintenance for installing a charging infrastructure.

In a case of the electric vehicle, the charging infrastructure may be installed at a relatively low cost because the charging is performed through power conversion in a current power system. However, in a case of the fuel cell electric vehicle, the unit costs of the installation of initial infrastructure such as a hydrogen station and hydrogen production technology are very expensive, so that it is not easy to proceed.

In the case of the fuel cell, unlike a general cell, reactants such as hydrogen and oxygen are converted into products to generate electrical energy. In recent years, as high-efficiency electrolysis technology through the fuel cell has been attracting attention, the hydrogen production technology is receiving a lot of attention.

With a specific operating principle, taking a solid oxide fuel cell (SOFC) which is a third-generation fuel cell as an example, oxygen is converted into oxygen ions at an air electrode by a chemical reaction, and then passes through an electrolyte, and reacts with hydrogen ions at a fuel electrode to generate water and an electric current.

When the fuel cell technology is reversely applied and a current is supplied to the SOFC, it becomes a solid oxide electrolysis cell (SOEC) that operates in a electrolysis mode that separates hydrogen and oxygen. As described above, the electrolysis cell separates and generates hydrogen and oxygen through the injection of steam and application of electric energy to the fuel electrode.

The ESS system is used for the purpose of storing electric energy, and now is efficiently used in conjunction with an emergency power network and an electric vehicle charging station.

As the supply and demand for fuel cell electric vehicles have recently increased, the demand for the hydrogen station is also increasing accordingly, but there is a problem in that supply and demand are not smooth because the supply unit price is too high. In addition, until now, neither the electric vehicle nor the fuel cell electric vehicle has an infrastructure capable of charging.

### PRIOR ART DOCUMENT

### Patent Document

Korean Patent Registration No. 10-1972778 (published on Apr. 26, 2019).

### SUMMARY OF INVENTION

### Technical Problem

An object of an embodiment of the present disclosure is to provide an ESS System for charging a fuel cell electric vehicle and an electric vehicle, which is capable of simultaneously charging the fuel cell electric vehicle and the electric vehicle by fusing an electric vehicle charging infrastructure and fuel cell electrolysis technology.

### Solution to Problem

According to an embodiment of the present disclosure, an ESS System for charging a fuel cell electric vehicle and an electric vehicle, includes a hydrogen tank that stores hydrogen and supplies the hydrogen to a fuel cell electric vehicle dispenser or a fuel cell stack pack; a fuel cell stack pack that operates in an electrolysis mode in which hydrogen is produced by using water and power received from a battery pack and transferred to the hydrogen tank, or in a fuel cell mode in which DC power is produced and transferred to a battery pack by using the hydrogen stored in the hydrogen tank and outside air; a battery pack that charges and stores DC power converted from AC power of a grid or power supplied from the fuel cell stack pack, and supplies the stored power to an electric vehicle dispenser; and a control unit that controls power transfer between the fuel cell stack pack and the battery pack and determines a driving mode of the fuel cell stack pack.

In addition, the control unit may determine a driving mode of the fuel cell stack pack based on at least one of a charging state of the battery pack and a storage amount of the hydrogen tank.

In addition, the control unit may operate the fuel cell stack pack in the fuel cell mode when the supply of AC power to the grid is cut off or the charge amount of the battery pack is less than a reference value.

In addition, the control unit may operate the fuel cell stack pack in the electrolysis mode when the charge amount of the battery pack is a reference value or more, or a storage amount of the hydrogen tank is less than a threshold value.

In addition, the fuel cell stack pack may consume water, which is produced when driving in the fuel cell mode, when driving in the electrolysis mode.

### Advantageous Effects

According to the present disclosure, it is possible to produce both hydrogen and power by fusing the electric vehicle charging infrastructure and the fuel cell electrolysis technology, and simultaneously charge the fuel cell electric vehicle and the electric vehicle.

### BRIEF DESCRIPTION OF DRAWINGS

FIG. 1 is a conceptual diagram of an ESS system for charging a fuel cell electric vehicle and an electric vehicle according to an embodiment of the present disclosure;

FIG. 2 is a diagram illustrating a configuration of the ESS system illustrated in FIG. 1 in more detail;

FIG. 3 is a diagram for explaining a driving mechanism of an electrolysis mode and a fuel cell mode of a fuel cell stack pack illustrated in FIG. 2; and

FIG. 4 is a diagram for further explaining FIG. 3.

### DETAILED DESCRIPTION OF EMBODIMENTS

Examples of the present disclosure will be described in detail with reference to the accompanying drawings so that those of ordinary skill in the art may easily implement the present disclosure. However, the present disclosure may be implemented in various different forms and is not limited to the examples described herein. In the drawings, portions irrelevant to the description are omitted in order to clearly describe the present disclosure, and similar reference numerals are attached to similar portions throughout the specification.

Throughout the specification, when a portion is said to be “connected” with another portion, this includes not only “directly connected” but also “electrically connected” with another element in the middle. In addition, when a portion “includes” a certain configuration element, it means that other configuration elements may be further included rather than excluding the other configuration elements unless specifically stated to the contrary.

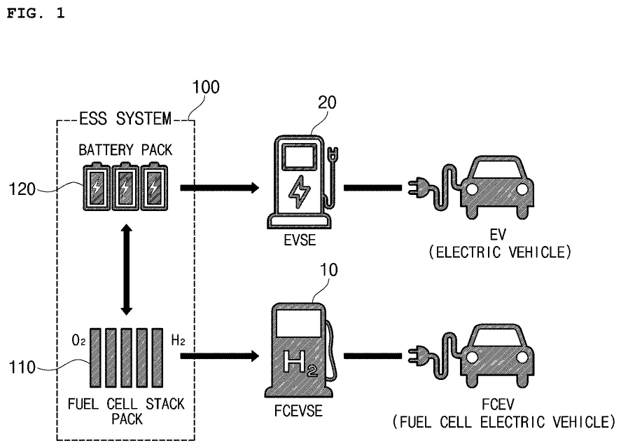

FIG. 1 is a conceptual diagram of an energy storage system (ESS) system for charging a fuel cell electric vehicle and an electric vehicle according to an embodiment of the present disclosure.

Referring to FIG. 1, an ESS system 100 according to the embodiment of the present disclosure includes both a fuel cell stack pack 110 and a battery pack 120, and a fuel cell electric vehicle (FCEV) and an electric vehicle (EV) each connected to a fuel cell electric vehicle dispenser (FCEVSE) and an electric vehicle dispenser (EVSE) 20 may be simultaneously charged.

In the embodiment of the present disclosure, the fuel cell stack pack 110 is capable of producing hydrogen as well as generating electricity and transfers the generated electricity to the battery pack 120 to use for charging the electric vehicle and stores the produced hydrogen in a hydrogen tank to use the hydrogen for charging the hydrogen vehicle.

That is, the fuel cell stack pack 110 may generate electricity from the hydrogen stored in the hydrogen tank and store the electricity in the battery pack 120, and use the electricity provided from the battery pack 120 to produce hydrogen and store the hydrogen in the hydrogen tank. The battery pack 120 may correspond to a general ESS battery.

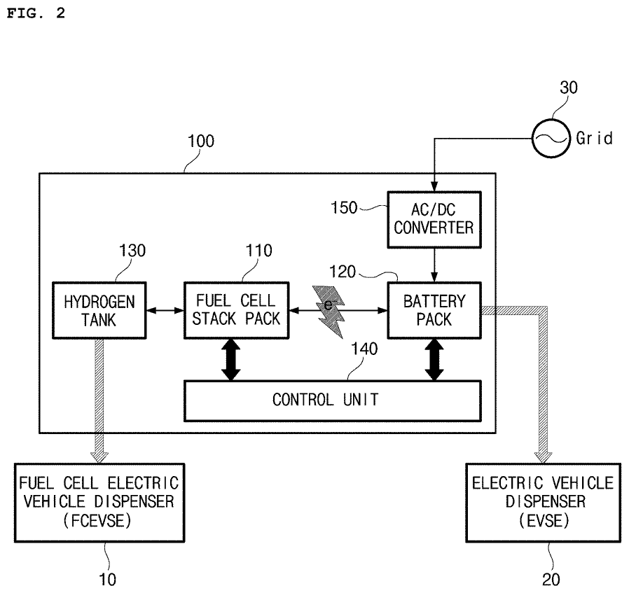

FIG. 2 is a diagram illustrating the configuration of the ESS system illustrated in FIG. 1 in more detail.

When the configuration of the ESS system 100 is described in more detail, as illustrated in FIG. 2, the ESS system 100 includes a hydrogen tank 130, the fuel cell stack pack 110, the battery pack 120, and a control unit 140. It is possible to simultaneously charge the fuel cell electric vehicle (hereinafter referred to as the hydrogen vehicle) and the electric vehicle (hereinafter referred to as the electric vehicle).

The hydrogen tank 130 stores hydrogen and supplies the stored hydrogen to the fuel cell electric vehicle dispenser 10 or the fuel cell stack pack 110. The hydrogen tank 130 may store hydrogen produced by the fuel cell stack pack 110 in addition to hydrogen supplied from an external source.

The fuel cell electric vehicle dispenser 10 generally includes a compressor, a pre-cooler, and a control unit. When the hydrogen vehicle is connected to a coupler, the fuel cell electric vehicle dispenser 10 serves to fill the hydrogen vehicle with the hydrogen supplied from the hydrogen tank 130. The fuel cell electric vehicle dispenser 10 may operate according to a hydrogen charging protocol standard such as

The fuel cell stack pack 110 has a structure in which fuel cell unit cells are stacked to form a stack and is disposed between the hydrogen tank 130 and the battery pack 120 to be driven. The fuel cell unit cell may include an air electrode, an electrolyte, and a fuel electrode.

Depending on the type of electrolyte, fuel cells are classified into a polymer electrolyte membrane fuel cell (PEMFC), a phosphoric acid fuel cell (PAFC), a molten carbonate fuel cell (MCFC), a solid oxide fuel cell (SOFC), and the like.

In the embodiment of the present disclosure, the solid oxide fuel cell (SOFC) is used as a representative example. In this case, the fuel cell stack pack 110 may be implemented as an SOFC stack.

In the embodiment of the present disclosure, the fuel cell stack pack 110 operates in two driving modes. One is an electrolysis mode in which hydrogen is produced by using electricity received from the battery pack 120 and supplied to the hydrogen tank 130, and the other is a fuel cell mode in which electricity is generated by using the hydrogen received from the hydrogen tank 130 and supplied to the battery pack 120.

The driving mode of the fuel cell stack pack 110 may be determined by the control unit 140.

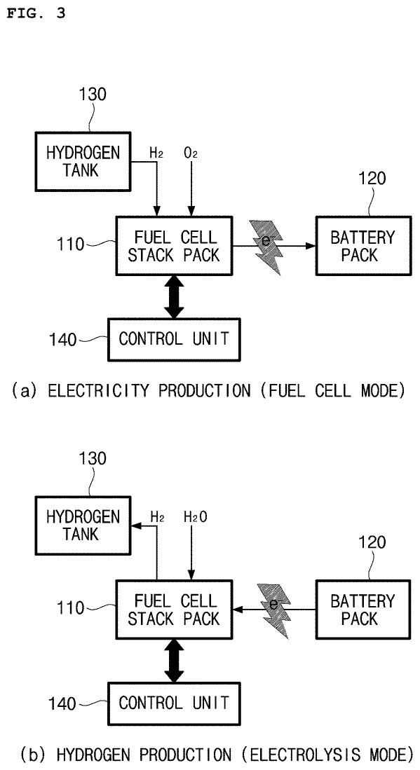

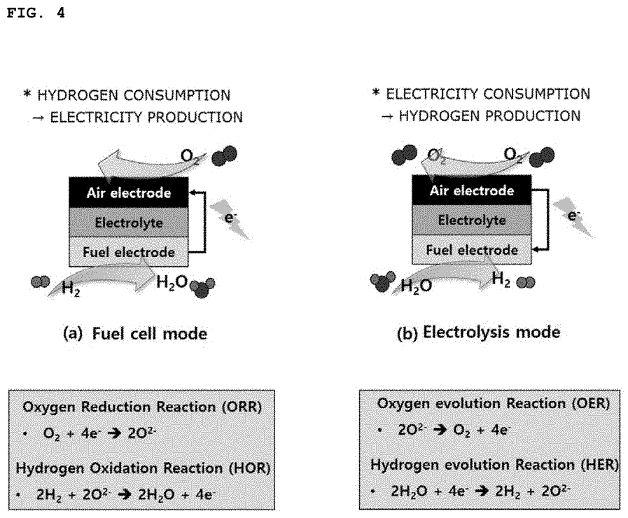

FIG. 3 is a diagram for explaining a driving mechanism of the electrolysis mode and the fuel cell mode of the fuel cell stack pack illustrated in FIG. 2, and FIG. 4 is a diagram for further explaining FIG. 3.

As illustrated in FIGS. 3 and 4, in the case of the fuel cell mode, hydrogen is consumed to produce electric energy, and in the case of the electrolysis mode, electric energy is consumed to produce hydrogen.

First, as illustrated in (a) of FIG. 3, in the fuel cell mode, electrons (el are generated by using hydrogen (H₂) stored in the hydrogen tank 130 and oxygen (O₂) in outside air, and electric energy produced therefrom is generated and transferred to the battery pack 120 to be charged.

That is, referring to (a) of FIG. 4, in the fuel cell mode, the hydrogen is consumed to produce the electricity, and looking at a reaction image and a reaction equation, it may be seen that oxygen (O₂) passes through the electrolyte and then reacts with hydrogen (H₂) at the fuel electrode to generate water (H₂O) and electrons (e⁻) (electrical energy).

Next, as illustrated in (b) of FIG. 3, in the electrolysis mode, hydrogen (H₂) is produced by using water (H₂O) and power (electrical energy) received from the battery pack 120 and transferred to the hydrogen tank 130 to be stored.

That is, referring to (b) of FIG. 4, in the electrolysis mode, it may be seen that electricity is consumed to produce hydrogen, and water (H₂O) and the electrons (e⁻) (electrical energy) are introduced into the fuel electrode and reacted to be separated into hydrogen (H₂) and oxygen (O₂). Here, of course, the fuel cell stack pack 110 may operate to consume water generated when driving the fuel cell mode for the hydrogen production, when driving the subsequent electrolysis mode.

As described above, in the case of the present disclosure, both electricity generation and hydrogen production are possible through the exchange of electric energy between the fuel cell stack pack 110 and the battery pack 120. Therefore, electric charging of the battery pack and hydrogen charging of the hydrogen tank may be additionally performed.

The battery pack 120 charges and stores the DC power converted from the AC power of the grid 30 or the power supplied from the fuel cell stack pack 110 and may supply the stored power to the electric vehicle dispenser 20. The battery pack 120 may correspond to a battery pack for a conventional ESS.

The electric vehicle dispenser 20 includes a power converter, a chiller (cooler), a control module, and the like, and when the electric vehicle is connected to a coupler, power received from the battery pack 120 is supplied to the electric vehicle to charge the electric vehicle. The electric vehicle dispenser 20 may operate according to an international standard such as ISO 15118.

An AC/DC converter 150 for converting AC power received from the grid 30 into DC power may be provided between the grid 30 and the battery pack 120. The AC/DC converter 150 may be included in the system 100 or may be connected to the outside of the system 100.

The control unit 140 may control the operation and driving states of the fuel cell stack pack 110, the battery pack 120, and the hydrogen tank 130, and monitor the state of each configuration element.

In addition, the control unit 140 may control power transfer between the fuel cell stack pack 110 and the battery pack 120 and may determine the driving mode of the fuel cell stack pack 110. The control unit 140 may control whether to transfer power, a transfer state, and a transfer direction according to the determined driving mode.

The control unit 140 may determine the driving mode of the fuel cell stack pack based on at least one of a charging state of the battery pack 120 and a storage amount of the hydrogen tank 130.

Specifically, in a case where the supply of AC power from the grid 30 to the battery pack 120 is cut off or the charge amount of the battery pack 120 is less than a preset reference value, the control unit 140 operates the fuel cell stack pack 110 in the fuel cell mode to compensate for insufficient power in the battery pack 120.

In addition, in a case where the charge amount of the battery pack 120 is the reference value or more, or the storage amount of hydrogen in the hydrogen tank 130 is less than the threshold value, the control unit 140 operates the fuel cell stack pack 110 in the electrolysis mode to compensate the capacity of the hydrogen tank 130.

As described above, the ESS system 100 according to the present disclosure may provide hydrogen produced by using the fuel cell stack pack 110 to the hydrogen tank 130, and electricity produced by using the fuel cell stack pack 110 may be provided to the battery pack 120.

According to the present disclosure as described above, it is possible to produce both hydrogen and electricity by fusing the existing charging infrastructure and the electrolysis technology, and simultaneously charge the fuel cell electric vehicle and the electric vehicle.

The present disclosure has been described with reference to the embodiments illustrated in the drawings, but these are only exemplary, and those of ordinary skill in the art will appreciate that various modifications and equivalent other embodiments are possible therefrom. Therefore, the true technical protection scope of the present disclosure should be determined by the technical spirit of the appended claims.

1. An ESS System for charging a fuel cell electric vehicle and an electric vehicle, comprising:
a hydrogen tank that stores hydrogen and supplies the hydrogen to a fuel cell electric vehicle dispenser or a fuel cell stack pack;
a fuel cell stack pack that operates in an electrolysis mode in which hydrogen is produced by using water and power received from a battery pack and transferred to the hydrogen tank, or in a fuel cell mode in which DC power is produced and transferred to a battery pack by using the hydrogen stored in the hydrogen tank and outdoor air;
a battery pack that charges and stores DC power converted from AC power of a grid or power supplied from the fuel cell stack pack, and supplies the stored power to an electric vehicle dispenser; and
a control unit that controls power transfer between the fuel cell stack pack and the battery pack and determines a driving mode of the fuel cell stack pack.

2. The ESS System for charging a fuel cell electric vehicle and an electric vehicle of claim 1,
wherein the control unit determines a driving mode of the fuel cell stack pack based on at least one of a charging state of the battery pack and a storage amount of the hydrogen tank.

3. The ESS System for charging a fuel cell electric vehicle and an electric vehicle of claim 1,
wherein the control unit operates the fuel cell stack pack in the fuel cell mode when the supply of AC power to the grid is cut off or the charge amount of the battery pack is less than a reference value.

4. The ESS System for charging a fuel cell electric vehicle and an electric vehicle of claim 1,
wherein the control unit operates the fuel cell stack pack in the electrolysis mode when the charge amount of the battery pack is a reference value or more, or a storage amount of the hydrogen tank is less than a threshold value.

5. The ESS System for charging a fuel cell electric vehicle and an electric vehicle of claim 1,
wherein the fuel cell stack pack consumes water, which is produced when driving in the fuel cell mode, when driving in the electrolysis mode.
